(19) United States
(12) Patent Application Publication
(10) Pub. No.: US 2012/0307021 A1
(43) Pub. Date: Dec. 6, 2012

(54) DUAL-MODE OPTICAL MEASUREMENT APPARATUS AND SYSTEM

(76) Inventors: Ming-June Tsai, Tainan City (TW); Hung-Wen Lee, Taipei City (TW); Hsueh-Yung Lung, Kaohsiung City (TW)

(21) Appl. No.: 13/188,724

(22) Filed: Jul. 22, 2011

(30) Foreign Application Priority Data
May 30, 2011 (TW) 100118875

(51) Int. Cl. H04N 13/02

(52) U.S. Cl. 348/50; 348/E13.074

(57) ABSTRACT

A dual-mode 3D optical measurement apparatus is applied to scan at least one object or capture the motion of at least one object. The optical measurement apparatus includes a light-projection unit, a plurality of marker units, and an image-capturing unit. The light-projection unit projects light on the object. The marker units are disposed at the object. When the dual-mode 3D optical measurement apparatus executes a static scan mode, the light-projection unit projects light on the surface of the static object, and then the image-capturing unit captures a plurality of static images of the object. When the dual-mode 3D optical measurement apparatus executes a motion capture mode, the image-capturing unit captures a plurality of motion images of the marker units. In addition, a dual-mode 3D optical measurement system is also disclosed.

### CROSS REFERENCE TO RELATED APPLICATIONS

This Non-provisional application claims priority under 35 U.S.C. §119(a) on Patent Application No(s). 100118875 filed in Taiwan, Republic of China on May 30, 2011, the entire contents of which are hereby incorporated by reference.

### BACKGROUND OF THE INVENTION

1. Field of Invention

The present invention relates to an optical measurement apparatus and, in particular, to a 3D optical measurement apparatus.

2. Related Art

Recently, the 3D optical measurement technology has been studied by academic researchers and developed for numerous industrial applications. The 3D optical measurement technology substantially includes two types: the measurement for static objects such as 3D scan and the measurement for movable objects such as motion track. The 3D scanning technology can be used in reverse engineering, quality control, industrial inspection, and rapid prototyping. In addition, the motion tracking technology can be used in virtual reality, gait analysis, bio-mechanics, ergonomics, and human factors engineering.

A conventional 3D optical measurement apparatus, which is known as a 3D scanner (e.g. body scanner), can only provide the scan function for the appearance of a static object (e.g. human body). It is unable to be used for motion capture of the object. In contrary, another conventional 3D optical measurement apparatus, which is known as a motion tracker, can only deal with the motion capture of an object. It is unable to perform the scan function for the appearance of the static object. If it is desired to obtain both the static scan function and the motion capture of a single object, the conventional 3D scanner and motion tracker must be integrated together. However, these conventional machines are usually expensive and only designed for single specific purpose. Their applications are limited and may not be widely spread. Besides, it is not so easy to integrate both functions of the static scan and the motion capture into an apparatus. Thus, a dual-mode 3D optical measurement apparatus and system, which can apply to not only the static scan but also the motion capture of the object, will be very important for the development of 3D optical measurement.

Therefore, it is an important subject of the invention to provide a dual-mode 3D optical measurement apparatus and a dual-mode 3D optical measurement system that can perform both of the static scanning and motion capturing for an object, thereby increasing the application of the invention.

### SUMMARY OF THE INVENTION

In view of the foregoing subject, an objective of the present invention is to provide a dual-mode 3D optical measurement apparatus and a dual-mode 3D optical measurement system that can perform both of the static scan and motion capture for an object, thereby increasing the application thereof.

To achieve the above objective, the present invention discloses a dual-mode 3D optical measurement apparatus applied to scan at least one object or capture the motion of at least one object. The optical measurement apparatus includes a light-projection unit, a plurality of marker units, and an image-capturing unit. The light-projection unit projects light on the object. The marker units are disposed at the object. When the dual-mode 3D optical measurement apparatus executes a static scan mode, the light-projection unit projects light on the surface of the static object, and then the image-capturing unit captures a plurality of images of the static object. When the dual-mode 3D optical measurement apparatus executes a motion capture mode, the image-capturing unit captures a sequence of images for the marker units during the object movement.

In one embodiment, the light emitted from the light-projection unit is encoded strip-structure light.

In one embodiment, the light emitted from the light-projection unit is progressive-scanned linear laser light.

In one embodiment, the marker units are luminous bodies.

In one embodiment, the marker units are patterned markers.

In one embodiment, the marker units have light reflectivity.

In one embodiment, the optical measurement apparatus further includes a static process unit and a motion process unit. The static process unit processes the scanned images to establish a static data structure with respect to the surface of the object. The motion process unit processes the motion images to establish a motion data structure with respect to the object.

In addition, the present invention also discloses a dual-mode 3D optical measurement system applied to scan at least one object or capture the motion of at least one object. The optical measurement system includes a plurality of the above-mentioned dual-mode 3D optical measurement apparatuses, which are disposed around the object for retrieving a plurality of scanned images and a plurality of motion images from different viewpoints, thereby establishing a plurality of static data structures and a plurality of motion data structures.

In one embodiment, the optical measurement system further includes a registration integration unit for processing the coordinate transformation between the dual-mode 3D optical measurement apparatuses.

In one embodiment, the registration unit further integrates the static data structures for obtaining a 3D surface data structure of the object.

In one embodiment, the registration unit further integrates the motion data structures for obtaining full motion information of the object.

As mentioned above, when the dual-mode 3D optical measurement apparatus executes a static scan mode, the light-projection unit projects light on the surface of the static object, and then the image-capturing unit captures a plurality of static images of the object. Otherwise, when the dual-mode 3D optical measurement apparatus executes a motion capture mode, the image-capturing unit captures a plurality of motion images of the marker units, which are attached to the object. Accordingly, the dual-mode 3D optical measurement apparatus of the invention can retrieve not only the static images of the object (static scan mode), but also the motion images of the object (motion capture mode). Since the optical measurement apparatus of the invention includes both the static scan mode and the motion capture mode, the integration of these two functions can be achieved.

In addition, the dual-mode 3D optical measurement system includes a plurality of the above-mentioned dual-mode 3D optical measurement apparatuses, which are disposed around the object for retrieving the static images and the motion images from different viewpoints. This can establish a plurality of static data structures and a plurality of motion data structures, thereby obtaining the full appearance and motion information of the object. Accordingly, the invention can obtain not only the images of the static object based on the appearance thereof but also a sequence of the motion images of the object for customizedly displaying the actual motion of the object, thereby broadening the application of the 3D optical measurement.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a side view of an object and a dual-mode 3D optical measurement apparatus according to a preferred embodiment of the invention;

FIG. 2A and FIG. 2B are schematic diagrams showing the gray codes and binary codes;

FIG. 3A is a schematic diagram showing a marker unit according to the preferred embodiment of the invention;

FIG. 3B is a schematic diagram showing a code pattern according to the preferred embodiment of the invention;

FIG. 3C is a schematic diagram showing the light-emitting elements disposed around the camera lens of the image-capturing unit;

FIG. 4A is a block diagram showing that the dual-mode 3D optical measurement apparatus executes a static scan mode;

FIG. 4B is a block diagram showing that the dual-mode 3D optical measurement apparatus executes a motion capture mode;

FIG. 5A is a schematic diagram showing a dual-mode 3D optical measurement system according to the preferred embodiment of the invention;

FIG. 5B is a block diagram of the dual-mode 3D optical measurement system according to the preferred embodiment of the invention; and

FIG. 5C is a schematic diagram showing that an object (human body) carries a plurality of marker units.

### DETAILED DESCRIPTION OF THE INVENTION

The present invention will be apparent from the following detailed description, which proceeds with reference to the accompanying drawings, wherein the same references relate to the same elements.

FIG. 1 is a side view of an object O and a dual-mode 3D optical measurement apparatus 1 according to a preferred embodiment of the invention. As shown in FIG. 1, the optical measurement apparatus 1 includes a light-projection unit 11, a plurality of marker units 12, and an image-capturing unit 13. The optical measurement apparatus 1 is applied to scan at least one object O or capture the motion of at least one object O. The object O can be a creature (e.g. human body or animal) or non-creature (e.g. vehicle or robot). In this embodiment, the object O is a human body for example. To be noted, the optical measurement apparatus 1 of FIG. 1 integrates the light-projection unit 11 and the image-capturing unit 13, which are configured inside an upright frame B.

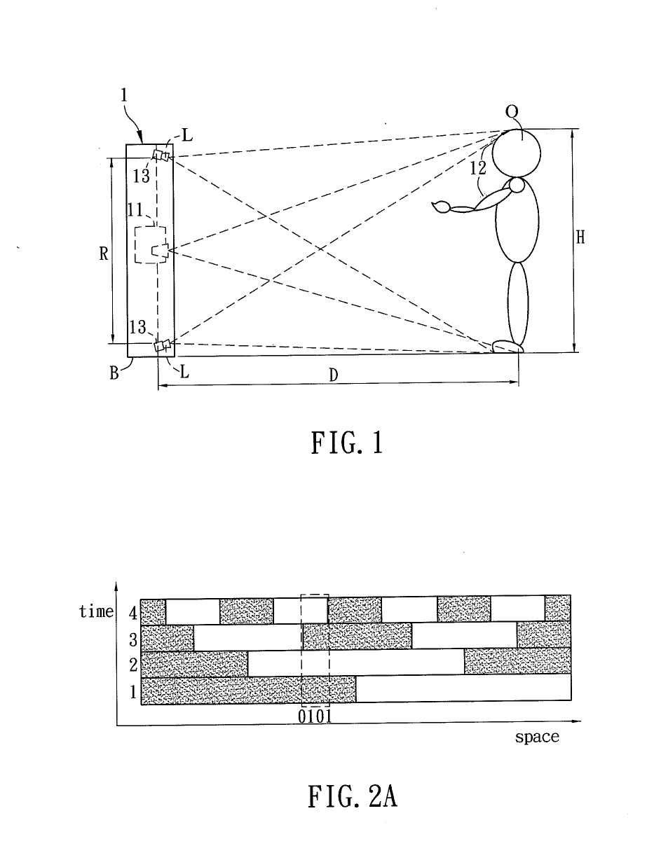

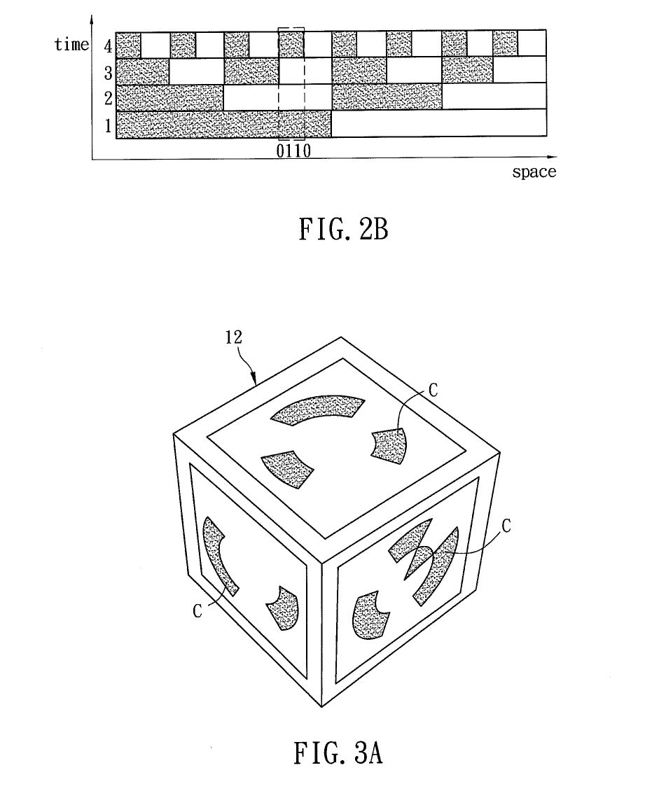

The light-projection unit 11 projects light on the surface of the object O. In this case, the light emitted from the light-projection unit 11 is encoded strip-structure light, and the encoded strip-structure light is projected on the surface of a static object O. Herein, the “static” object O means that the object O is in a static state. The strip-structure light may be encoded with the 4-bit gray code as shown in FIG. 2A or with the 4-bit binary code as shown in FIG. 2B. Regarding to the gray code of FIG. 2A, only one bit change is set between two positions, and the strip width of the gray code is almost twice of the binary code under the same conditions. Thus, the gray code is superior to the binary code in the comparison and recognition while capturing the strip code image. In addition, the light emitted from the light-projection unit 11 can be a line projected on the object O by a laser diode. The advantage of the strip-structure light is that the surface shape information of the object O can be captured at the same time. In contrary, since the laser light projected on the surface of the object O is a straight line, it must progressive scan the object O from top to bottom or from bottom to top for capturing the surface shape information of the object O. It usually takes much more time to perform the progressive scan method.

In this embodiment, the light-projection unit 11 is a liquid-crystal projector, and the projected light is strip-structure light, which is encoded by gray code. In more detailed, the strip-structure light projected by the light-projection unit 11 contains 14 encoded patterns, which include 8 gray code strip patterns, 4 phase shift patterns, a full black pattern and a full white pattern. Thus, it can provide 1024 (4×2⁸) sets of gray code images. To be noted, the above 1024 set of gray code images are for illustrations only and are not to limit the scope of the invention, and the strip-structure light may have other numbers of sets of gray code images in other embodiments.

With reference to FIG. 1, a plurality of marker units 12 (FIG. 1 shows two marker units 12 for example) are attached to the surface of the object O. The marker unit 12 can be an active marker unit or a passive marker unit. For example, the active marker unit, such as a luminous body, may emit light itself, so that the image-capturing unit 13 can capture and identify the images thereof. In contrary, the passive marker unit can not emit light itself, but it may have the light reflectivity and contain the encoded pattern. Accordingly, a light source is necessary to provide light toward the passive marker unit, so that the reflected light from the passive marker unit can be captured and identified. In practice, the passive marker unit may contain a pattern attached to a surface of a plane; otherwise, it may contain a plurality of patterns attached to a plurality of surfaces of a polyhedron, such as a pyramid, cube, cuboid, or the likes.

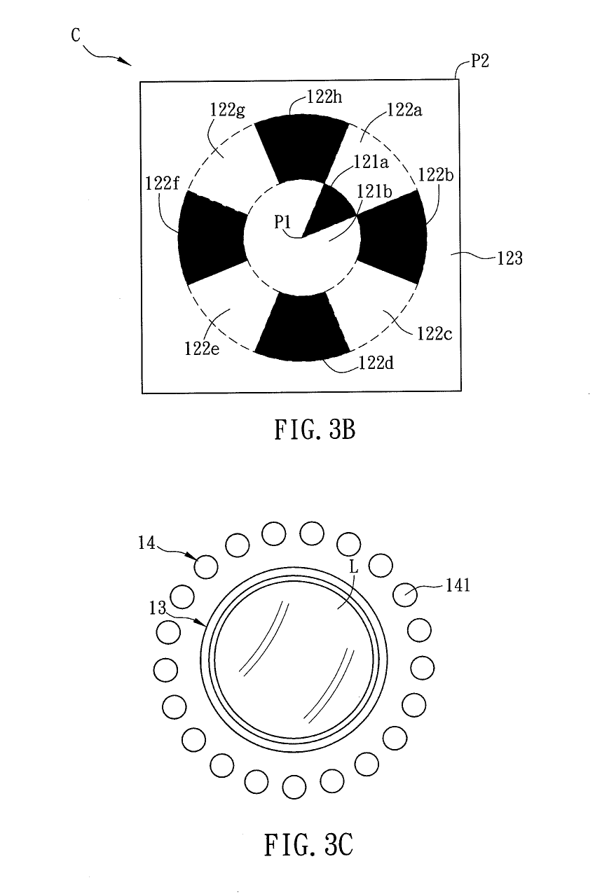

Reference to FIG. 3A, the marker unit 12 is a cube, and a plurality of encoded patterns C as shown in FIG. 3B are attached to the surfaces of the cube. In practice, 5 surfaces of the cube are attached with the encoded patterns C, and the residual surface of the cube used for attaching to the object O is not attached with the encoded pattern C. In order to identify the different positions of the object O, the encoded patterns C of different surfaces of the marker unit 12 have different codes. Before using the dual-mode 3D optical measurement apparatus 1, the different positions of the object O are configured with a plurality of marker units 12, which are cubes with the encoded patterns C. Since the relative positions between the surfaces of the cube of FIG. 3A are fixed, it is possible to obtain the coordinates of the surface without the pattern by processing the coordinate transformation of the surfaces with the encoded patterns C. Accordingly, if the moving marker units 12 are captured, the motion information of the particular positions of the object O can be obtained.

The encoding rule of the encoded pattern C will be illustrated hereinbelow with reference to FIG. 3B. As shown in FIG. 3B, the encoded pattern C includes an inner pattern and an outer pattern. The inner pattern is divided into a plurality of first regions, and the outer pattern is divided into a plurality of second regions. The color of at least one of the first regions is different from that of at least one of the second regions. In this embodiment, the peripheries of the inner pattern and the outer pattern are circles, and the inner pattern is divided into two first regions 121a and 121b, which are sectors with different areas for example. In addition, the second regions form an annular pattern defined between the circular peripheries of the inner pattern and the outer pattern. In this case, the outer pattern is divided into 8 second regions 122a to 122h, each of which is formed by two radiuses and the peripheries of the inner and outer patterns. The areas of the second regions 122a to 122h are the same.

The encoded pattern C may further include a square frame 123, and the inner and outer patterns are disposed inside the square frame 123. In the embodiment, the inner and outer patterns are symmetrically disposed in the corresponding square frames 123. The square frame 123, the inner pattern and the outer pattern have the same geometric center. For example, the geometric center P1 is the intersection point of the diagonal lines of the square frame 123. Based on the specific relation of the inner pattern and the square frame (e.g. the first region 121a of the inner pattern aligns toward a corner P2 of the square frame 123), the recognition speed of the outer pattern can be increased, thereby improving the accuracy of code identifying. To be noted, it is possible to remove the square frame 123, and the encoded pattern C including only the inner and outer patterns can still provide the encoding function.

In the encoding rule of the embodiment, “1” represents black while “0” represents white, and vice versa. As shown in FIG. 3B, the first region 121a is black, and the first region 121b is white. Accordingly, the inner pattern is encoded as “1”. Alternatively, if the first region 121a is white and the first region 121b is black, the inner pattern is encoded as “0”. As a result, the inner pattern of the embodiment can be encoded as “1” or “0”.

After the position of the first region 121a is determined, the second code is referred to the color of the second region 122a corresponding to the periphery of the first region 121a, and the position of the second region 122a represents a start position. The color of the position of the second region 122b represents the third code, and the color of the position of the second region 122c represents the fourth code. Similarly, following the clockwise direction, the color of the position of the second region 122h represents the ninth code. According to the encoding rule of the embodiment, the encoded pattern C can have 512 (2) combinations. This is enough for representing the different positions of the surface of the object O. Referring to FIG. 3B, the first to ninth codes are “101010101”. To be noted, the above-mentioned encoding rule is for example only and is not to limit the application of the marker units 12 of the embodiment. In addition, based on the specific relation of the first region 121a and the corner P2 of the square frame 123, the recognition speed of the second region 122a can be increased, thereby improving the accuracy of code identifying.

In order to cooperate with the above-mentioned passive marker units 12, the dual-mode 3D optical measurement apparatus 1 further includes a light-emitting unit 14, which emits light to the marker units 12 on the surface of the object O. As shown in FIG. 3C, the light-emitting unit 14 includes a plurality of light-emitting elements 141, which are disposed around at least one camera lens L of the image-capturing unit 13 for providing co-axial light. The relative positions between the light-emitting elements 141 and the camera lens L are fixed. In the embodiment, as shown in FIG. 1, the image-capturing unit 13 includes two CCD (charge coupled device) cameras, which are disposed at two sides of the light-projection unit 11. The light-emitting elements 141 are disposed around two camera lenses of FIG. 1, and they are, for example, light-emitting diodes for emitting red light. Of course, in other embodiments, the light-emitting elements 141 may emit light of other colors. Otherwise, the light-emitting elements 141 may be laser diodes that emit laser. As shown in FIG. 1, the distance R between two camera lenses L is about 1450 mm, the distance D between the object O and the dual-mode 3D optical measurement apparatus 1 is about 2700 mm, and the height H of the object O is about 1900 mm. To be noted, if the marker units 12 are active marker units, which can emit light themselves, the above-mentioned light-emitting unit 14 is not needed.

Referring to FIG. 1, when a static scan mode is executed, the light-projection unit 11 projects light on the surface of the object O, and then the image-capturing unit 13 captures a plurality of static images of the object O. In this embodiment, the light emitted from the light-projection unit 11 is strip-structure light with gray code. Thus, the images captured by the image-capturing unit 13 are strip images of the object O.

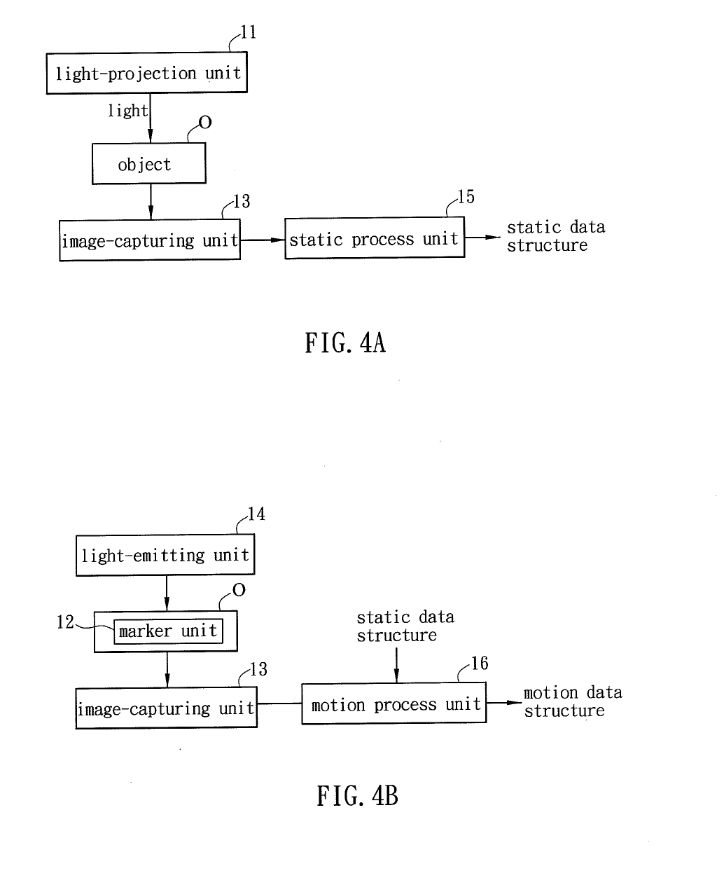

FIG. 4A is a block diagram showing that the dual-mode 3D optical measurement apparatus 1 executes a static scan mode.

The dual-mode 3D optical measurement apparatus 1 includes a static process unit 15 for receiving and processing the static images (strip images with gray code) captured by the image-capturing unit 13 to establish a static data structure with respect to the surface of the object O. The static process unit 15 can obtain the spatial orientation of the surface of the object O according to the captured static images by utilizing trigonometry (also known as triangle location or stereo vision method). This process can locate the position of the surface of the object O so as to obtain the dense dots data, which indicate the spatial coordinates of the scan points on the surface of the object O, thereby establishing the static data structure with respect to the surface of the object O.

Referring to FIG. 1 again, when the motion capturing is executed, the object O (e.g. human body) has dynamic motions. For example, the human body may raise his/her hand or leg. In this case, the marker units 12 attached to the object O are moved along with the object O. The image-capturing unit 13 captures the motion images of the marker units 12 attached to the object O. In this embodiment, each of the marker units 12 is a 3D patterned marker as shown in FIG. 3A. In order to cooperate with the marker units 12 of FIG. 3A, the dual-mode 3D optical measurement apparatus 1 further includes a light-emitting unit 14, which emits co-axial light to the surface of the object O. Since the marker units 12 are disposed on the specific positions on the human body in advance, the images captured by the image-capturing unit 13 represent the reflected encoded images of the marker units 12 while the marker units 12 move along with the object O.

FIG. 4B is a block diagram showing that the dual-mode 3D optical measurement apparatus 1 executes a motion capture mode.

The dual-mode 3D optical measurement apparatus 1 further includes a motion process unit 16 for receiving and processing the motion images (encoded images reflected by the marker units 12) captured by the image-capturing unit 13 to establish a motion data structure with respect to the surface of the object O. Moreover, the motion process unit 16 can further establish the motion data structure with respect to the surface of the object O according to the motion images and the static data structure outputted by the static process unit 15. In this embodiment, the motion process unit 16 can process the spatial orientation according to the captured motion images by utilizing trigonometry. This process can obtain the motion values of the marker units 12 on the surface of the object O such as displacement, velocity, acceleration and the likes. Then, the motion data structure of the object O can be established according to the obtained motion values and the static data structure.

As mentioned above, the dual-mode 3D optical measurement apparatus 1 can not only obtain the static images according to the surface of the object O so as to establish the static data structure of the surface of the object O, but also obtain the motion images of the object O so as to establish the motion data structure of the object O. In addition, since the static scanning of the appearance of the object O and the capturing of the motion status thereof can be integrated in the dual-mode 3D optical measurement apparatus 1, the problem of the prior art that needs two 3D optical measurement apparatuses for respectively providing the two functions can be solved. Thus, the cost can be reduced.

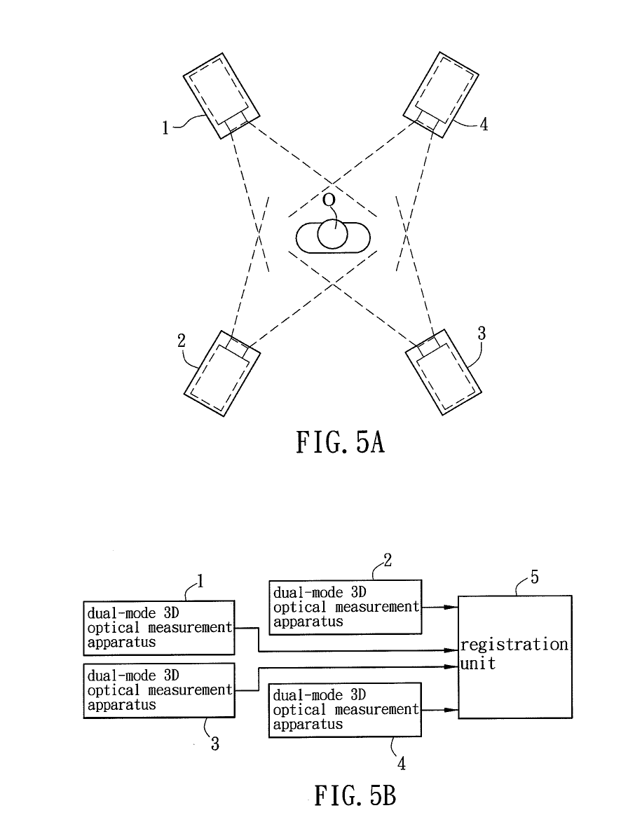

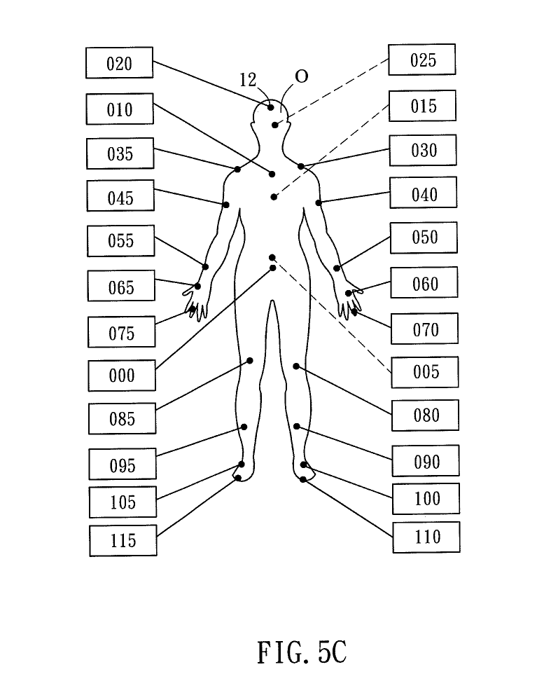

FIG. 5A is a schematic diagram showing a dual-mode 3D optical measurement system according to the preferred embodiment of the invention. As shown in FIG. 5A, the dual-mode 3D optical measurement system, which is used to scan at least one object O or capture the motion of at least one object O, includes a plurality of the above-mentioned dual-mode 3D optical measurement apparatuses. The dual-mode 3D optical measurement apparatuses are disposed around the object O for retrieving a plurality of static images and a plurality of motion images from different viewpoints, thereby establishing a plurality of static data structures and a plurality of motion data structures.

In this embodiment, the dual-mode 3D optical measurement system includes 4 dual-mode 3D optical measurement apparatuses 1-4. The characteristics and functions of the dual-mode 3D optical measurement apparatuses 2-4 are the same as the above-mentioned dual-mode 3D optical measurement apparatus 1, so the detailed descriptions thereof are omitted. In the dual-mode 3D optical measurement system, the dual-mode 3D optical measurement apparatuses 1 and 3 are defined as a first group, and the dual-mode 3D optical measurement apparatuses 2 and 4 are defined as a second group. The dual-mode 3D optical measurement apparatuses 1 and 3 are disposed opposite to each other, and the dual-mode 3D optical measurement apparatuses 2 and 4 are disposed opposite to each other. In addition, the dual-mode 3D optical measurement system may control the dual-mode 3D optical measurement apparatuses 1 and 3 of the first group to project the light in advance and then capture a plurality of static images and a plurality of motion images from different viewpoints. After that, the dual-mode 3D optical measurement system may control the dual-mode 3D optical measurement apparatuses 2 and 4 of the second group to project the light and then capture a plurality of static images and a plurality of motion images from different viewpoints.

FIG. 5B is a block diagram of the dual-mode 3D optical measurement system according to the preferred embodiment of the invention. In this embodiment, the dual-mode 3D optical measurement system further includes a registration unit 5 for processing a coordinate transfer between the dual-mode 3D optical measurement apparatuses 1-4. In more detailed, the registration unit 5 integrates the static data structures according to the relationships between the same marker units 12 on the object O. Thus, the registration unit 5 can integrate the static data structures for obtaining a 3D surface data structure of the object O. In other words, each dual-mode 3D optical measurement apparatus has independent static scanning and motion tracking abilities under its own coordinate system. Accordingly, if it is desired to perform the further calculation with respect to the same object O, the registration procedure must be executed for transferring the separate coordinates of the dual-mode 3D optical measurement apparatuses to the same coordinate system. In this case, the registration unit 5 can execute the registration procedure to integrate the separate coordinate systems of the dual-mode 3D optical measurement apparatuses 1-4 to the same coordinate system.

FIG. 5C is a schematic diagram showing that an object O (e.g. human body) carries a plurality of marker units 12. As shown in FIG. 5C, the object O carries totally 24 marker units 12, wherein the marker units 12 of numbers 005, 015 and 025 are disposed on the rear surface of the human body, and the residual 21 marker units 12 are disposed on the front surface of the human body. To be noted, the numbers and positions of the marker units 12 of FIG. 5C are for illustration only, and it is possible to disposed the marker units 12 in different way, such as different numbers and different positions.

The registration unit 5 may further integrate the different viewpoints provided by the dual-mode 3D optical measurement apparatuses 1-4, so that the loss of the motion information of the marker units 12 caused by the blocked light can be prevented. Thus, the full motion data structure of the object O can be obtained. In other words, the registration unit 5 can integrate the motion data structures for obtaining full motion information of the object O.

Moreover, since the registration unit 5 can integrate the static data structures for obtaining a 3D surface data structure of the object O and integrate the motion data structures for obtaining full motion information of the object O, the real motion images of the object O can be shown by replication.

In summary, when the dual-mode 3D optical measurement apparatus executes a static scan mode, the light-projection unit projects light on the surface of the static object, and then the image-capturing unit captures a plurality of static images of the object. Otherwise, when the dual-mode 3D optical measurement apparatus executes a motion capture mode, the image-capturing unit captures a plurality of motion images of the marker units, which are disposed at the object. Accordingly, the dual-mode 3D optical measurement apparatus of the invention can retrieve not only the static images of the object (static scan mode), but also the motion images of the object (motion capture mode). Since the optical measurement apparatus of the invention includes both the static scan mode and the motion capture mode, the combination of these two functions can be achieved.

In addition, the dual-mode 3D optical measurement system includes a plurality of the above-mentioned dual-mode 3D optical measurement apparatuses, which are disposed around the object for retrieving the static images and the motion images from different viewpoints. This can establish a plurality of static data structures and a plurality of motion data structures, thereby obtaining the full appearance and motion information of the object. Accordingly, the invention can simultaneously obtain both the static images of the object based on the appearance thereof and the motion images of the object for customizedly displaying the actual motion of the object, thereby broadening the application of the 3D measurement.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dual-mode 3D optical measurement apparatus, comprising:
a light-projection unit projecting light on an object;
a plurality of marker units disposed at the object; and
an image-capturing unit, wherein when the dual-mode 3D optical measurement apparatus executes a static scan mode, the light-projection unit projects the light on a surface of the static object, and then the image-capturing unit captures a plurality of static images of the object, or when the dual-mode 3D optical measurement apparatus executes a motion capture mode, the image-capturing unit captures a plurality of motion images of the marker units.

2. The optical measurement apparatus according to claim 1, wherein the light emitted from the light-projection unit is encoded strip-structure light.

3. The optical measurement apparatus according to claim 1, wherein the light emitted from the light-projection unit is progressive-scanned linear laser light.

4. The optical measurement apparatus according to claim 1, wherein the marker units are luminous bodies.

5. The optical measurement apparatus according to claim 1, wherein the marker units are patterned markers.

6. The optical measurement apparatus according to claim 1, wherein the marker units comprises light reflectivity.

7. The optical measurement apparatus according to claim 1, further comprising:
a static process unit for processing the static images to establish a static data structure with respect to the surface of the object; and
a motion process unit for processing the motion images to establish a motion data structure with respect to the object.

8. A dual-mode 3D optical measurement system, which comprises a plurality of dual-mode 3D optical measurement apparatuses, wherein each of the dual-mode 3D optical measurement apparatus comprises:
a light-projection unit projecting light on an object;
a plurality of marker units disposed at the object; and
an image-capturing unit, wherein when the dual-mode 3D optical measurement apparatus executes a static scan mode, the light-projection unit projects the light on a surface of the static object, and then the image-capturing unit captures a plurality of static images of the object, or when the dual-mode 3D optical measurement apparatus executes a motion capture mode, the image-capturing unit captures a plurality of motion images of the marker units;
wherein, the dual-mode 3D optical measurement apparatuses are disposed around the object for retrieving the static images and the motion images from different viewpoints, thereby establishing a plurality of static data structures and a plurality of motion data structures.

9. The optical measurement system according to claim 8, wherein the light emitted from the light-projection unit is encoded strip-structure light.

10. The optical measurement system according to claim 8, wherein the light emitted from the light-projection unit is progressive-scan linear laser light.

11. The optical measurement system according to claim 8, wherein the marker units are luminous bodies.

12. The optical measurement system according to claim 8, wherein the marker units are patterned markers.

13. The optical measurement system according to claim 8, wherein the marker units comprises light reflectivity.

14. The optical measurement system according to claim 8, wherein each of the dual-mode 3D optical measurement apparatuses further comprises:
a static process unit for processing the static images to establish the corresponding static data structure with respect to the surface of the object; and
a motion process unit for processing the motion images to establish the corresponding motion data structure with respect to the object.

15. The optical measurement system according to claim 8, further comprising:
a registration unit for processing a coordinate transfer between the dual-mode 3D optical measurement apparatuses.

16. The optical measurement system according to claim 15, wherein the registration unit further integrates the static data structures for obtaining a 3D surface data structure of the object.

17. The optical measurement system according to claim 15, wherein the registration unit further integrates the motion data structures for obtaining full motion information of the object.
